(19) United States
(12) Patent Application Publication
(10) Pub. No.: US 2024/0151071 A1
(43) Pub. Date: May 9, 2024

(54) Deadbolt drive mechanism, handle fixing mechanism, and intelligent recreational vehicle lock

(71) Applicant: Shenzhen Hanmai Technology Co., Ltd, Shenzhen (CN)

(72) Inventor: Wenyuan Zhang, Zhangshu (CN)

(21) Appl. No.: 18/413,090

(22) Filed: Jan. 16, 2024

(30) Foreign Application Priority Data
Feb. 8, 2023 (CN) 202320157201.7
Feb. 8, 2023 (CN) 202320157202.1
Feb. 8, 2023 (CN) 202320157204.0

(51) Int. Cl. E05B 81/06; E05B 81/18; E05B 81/30; E05B 81/36; E05B 81/56; E05B 83/44; E05B 85/06

(52) U.S. Cl. CPC E05B 81/06; E05B 81/18; E05B 81/30; E05B 81/36; E05B 81/56; E05B 83/44; E05B 85/06

(57) ABSTRACT

The present disclosure relates to the technical field of recreational vehicle locks, and in particular, to a deadbolt drive mechanism, a handle fixing mechanism, and an intelligent recreational vehicle lock. The intelligent recreational vehicle lock includes a deadbolt drive mechanism, a handle fixing mechanism, an inner lock body, an outer lock body, a lock cylinder assembly, and an intelligent control component; the lock cylinder is connected between the inner lock body and the outer lock body; the deadbolt drive mechanism is arranged in the lock cylinder assembly; the handle fixing mechanism is arranged on the outer lock body; the intelligent control component is provided with a control device, a power supply device, a password setting assembly, a password inputting assembly, and a locking button which are electrically connected to each other.

### TECHNICAL FIELD

The present disclosure relates to the technical field of recreational vehicle locks, and in particular, to a deadbolt drive mechanism, a handle fixing mechanism, and an intelligent recreational vehicle lock.

### BACKGROUND

A recreational vehicle, also referred to as motor caravan, can be parked on beaches, lakeshores, grasslands, slopes, and forests that are far from cities. In addition to a driving region, the recreational vehicle generally has a spacious living region. This living region is usually isolated from the driving region. Therefore, the living region is required to be provided with a separate door lock.

A traditional recreational vehicle door lock is usually constructed using a household door lock mechanism. For example, a door is opened and closed through a link. However, there is a difference in use between the recreational vehicle door lock and a household door lock. The recreational vehicles need to move and are often driven on a road. Some recreational vehicles may also pass through bumpy non-urban roads, so a higher requirement is put for the recreational vehicle door lock.

When the ordinary household door lock is used on the recreational vehicle, the stability is poor, and the link is easily separated. As a result, the recreational vehicle lock gets stuck easily, or is difficult to open, or is automatically opened due to the bumps on the road, causing accidents.

Therefore, how to provide a structurally reliable and highly stable deadbolt drive mechanism on a frequently moving and bumpy recreational vehicle is a technical problem that needs to be solved.

In addition, when a vehicle is driving at a high speed or experiencing severe bumps, it is also easy for a door handle to shake severely synchronously, which can cause certain impact damage to a lock cylinder. At the same time, an impact sound is made, which leads to abnormal noises problem and affects the experience of a user in the living region of the recreational vehicle.

Moreover, frequent impacts can easily lead to damage to the lock cylinder, so that the cost of replacing the lock cylinder is also relatively high, causing significant loss to the user. Therefore, how to provide a structurally reliable, highly stable, and cost-effective handle fixing mechanism for the recreational vehicle door lock is a technical problem that needs to be solved.

Some recreational vehicle locks are additionally provided with numerical password unlocking devices or remote unlocking devices, which further improves the safety of the recreational vehicle locks. However, in practical use, there may also be some shortcomings, such as complex password setting and password inputting processes and cumbersome operations. There may even be situations where a remote key is lost or a password is leaked. If the password cannot be changed or a new remote key cannot be made in a timely manner, there is a risk that the recreational vehicle lock is opened by others.

Therefore, it is particularly important to improve the safety as soon as possible after the remote key is lost or the password is leaked. This is also a technical problem that needs to be solved.

### SUMMARY

In order to overcome the drawbacks described above, the present disclosure aims to provide technical solutions capable of solving the above problems.

The present disclosure provides a deadbolt drive mechanism, including a lock body base, a deadbolt assembly, and a drive assembly, wherein the deadbolt assembly and the drive assembly are connected to the lock body base; one end of the deadbolt assembly is provided with a deadbolt clamping tooth and extends into the lock body base; the drive assembly is provided with a drive gear; and the drive gear is in meshing connection to the deadbolt clamping tooth to drive the deadbolt assembly to move.

Further, the drive assembly is provided with a rotating shaft body; the rotating shaft body is connected to the lock body base; the drive gear and the rotating shaft body are coaxially arranged and are fixedly connected to each other; and the drive gear rotates synchronously with the rotating shaft body.

Further, the deadbolt drive mechanism includes an internal knob; a central axis of the internal knob overlaps a central axis of the rotating shaft body; the internal knob is fixedly connected to the rotating shaft body; and the internal knob drives the rotating shaft body to rotate.

Further, the deadbolt drive mechanism further includes a mechanical lock cylinder; a central axis of the mechanical lock cylinder overlaps a central axis of the rotating shaft body; the mechanical lock cylinder is in buckled connection with the rotating shaft body; and the mechanical lock cylinder drives the rotating shaft body to rotate.

Further, the deadbolt drive mechanism further includes an electric lock cylinder; the electric lock cylinder is connected to the lock body base; the electric lock cylinder is in meshing connection to the drive assembly; and the electric lock cylinder drives the drive assembly to rotate to drive the deadbolt assembly to move.

Further, the electric lock cylinder is provided with a speed reduction motor and a driving gear; the speed reduction motor is connected to the lock body base; the driving gear is connected to an output shaft of the speed reduction motor; the speed reduction motor drives the driving gear to rotate; the drive gear is provided with a driven wheel tooth; the driven wheel tooth form a sector gear on the drive gear; the sector gear is in meshing connection to the driving gear, so that the driving gear drives the sector gear to rotate and drives the drive gear to rotate.

The present disclosure further provides an intelligent recreational vehicle lock, including the deadbolt drive mechanism described above, further including an inner lock body, an outer lock body, a lock cylinder assembly, and an intelligent control component, wherein the lock cylinder assembly is connected between the inner lock body and the outer lock body; the intelligent control component is electrically connected to the lock cylinder assembly and controls opening and closing of the lock cylinder assembly; the lock cylinder assembly is provided with an electric lock cylinder; opening and closing of the electric lock cylinder drives the deadbolt assembly to move, thereby opening and closing the recreational vehicle lock; the intelligent control component is provided with a control device, a power supply device, a password setting assembly, a password inputting assembly, and a locking button which are electrically connected to each other; the password setting assembly is configured to set a numerical password; the password inputting assembly is configured to input the numerical password; the control device is configured to compare whether an input numerical password is consistent with a set numerical password and drive the electric lock cylinder to achieve opening and closing operations; and the locking button is configured to turn off the control device, so that the control device is unable to control the electric lock cylinder to perform the opening and closing operations.

Further, the password setting assembly is provided with a set button, a del button, a mute button, and a reset button; the set button is configured to preset a corresponding password; the del button is configured to delete the corresponding password; the mute button is configured to enable the control device to send a muting signal; and the reset button is configured to restore factory settings of the intelligent control component.

Further, the password inputting assembly is provided with a number button, an ok button, and a logo button; the number button is configured to input a corresponding numerical password; the ok button is configured to confirm that inputting of the input numerical password has been completed; the logo button is configured to directly send a double-lock signal; and after receiving the double-lock signal, the control device directly controls the electric lock cylinder to perform a locking operation.

Further, the intelligent recreational vehicle lock includes a remote control component; the remote control component is provided with a remote control chip, a signal sending device, a remote control locking button, and a remote control unlocking button which are electrically connected to each other; the remote control locking button is configured to send an electrical signal for locking, and the remote control unlocking button is configured to send an electrical signal for unlocking; the remote control chip is configured to store preset matching information and generate opening and closing information in combination with the electrical signals; and the signal sending device is configured to send the opening and closing information to the control device.

Further, the control device is provided with a control chip, a signal receiving device, and a buzzer which are electrically connected to each other; the signal receiving device is configured to receive the opening and closing information sent by the signal sending device; the control chip performs corresponding opening and closing control on the electric lock cylinder according to the opening and closing information; and the buzzer is configured to make a prompt tone or enter a mute state according to a signal sent by the control chip.

Further, the lock cylinder assembly is further provided with a mechanical lock cylinder; the mechanical lock cylinder is connected to the lock cylinder assembly; the mechanical lock cylinder is in buckled connection to the deadbolt assembly and drives the deadbolt assembly to move a certain distance to perform the opening and closing operations on the recreational vehicle lock; the inner lock body is further provided with an internal knob; one end of the internal knob that penetrates into the lock cylinder assembly is connected to a rotating shaft of the mechanical lock cylinder; and the internal knob is configured to drive the rotating shaft to rotate and drive the deadbolt assembly to move to perform the opening and closing operations on the recreational vehicle lock.

Further, the remote control component is provided with a mechanical key; the mechanical key is fixedly connected to the remote control component in a removable manner; and the mechanical key is configured to open the mechanical lock cylinder.

Further, the lock cylinder assembly is provided with a spring bolt and an unlocking spring; the spring bolt is movably connected to the lock cylinder assembly; one end of the unlocking spring presses against the spring bolt, and the other end of the unlocking spring presses against the lock cylinder assembly; the inner lock body is further provided with an interior handle; one end of the interior handle that penetrates into the lock cylinder assembly presses against the spring bolt; and the interior handle is configured to drive the spring bolt to achieve an unlocking operation.

The present disclosure further provides a handle fixing mechanism, including the intelligent recreational vehicle lock described above, and further including an outer shell, an exterior handle, and an external knob, wherein the outer shell is connected to the outer lock body and is provided with a locking disk and a locking through hole; the exterior handle is provided with a limiting circular ring, a rotating through hole, an accommodating chamber, and an accommodating through hole; the accommodating chamber is fixedly connected to the limiting circular ring and forms a cavity; the external knob is mounted in the cavity; one end of the external knob is provided with a rotating grip; the rotating grip passes through the rotating through hole and protrudes out of the exterior handle; the other end of the external knob is provided with a rotating buckle; and the rotating buckle is buckled on the locking disk through the accommodating through hole and the locking through hole.

Further, the accommodating chamber is provided with a fixing ring and an accommodating spring; the fixing ring is arranged around the accommodating through hole and is fixedly connected to the accommodating chamber; the external knob is provided with a limiting round disk; one end of the accommodating spring presses against the fixing ring; and the other end presses against the limiting round disk.

Further, the exterior handle is provided with a limiting convex block; the limiting convex block is located on a limiting circular ring; the external knob is provided with a limiting notch; the limiting notch is located on the limiting round disk; and the limiting convex block is in buckled connection to the limiting notch to limit a rotation state of the external knob.

Further, the rotating buckle is set to be a straight type buckle; the locking through hole is set to be a straight type through hole; and the rotating buckle and the locking through hole cooperate with each other, so that the rotating buckle passes through the locking through hole.

Further, the outer shell is provided with a support frame and a support hole; the support frame is fixedly connected to the outer shell; the exterior handle is provided with a support rotating shaft; and the support rotating shaft passes through the support hole to form a rotatable connection.

Further, the exterior handle is provided with an unlocking lever; and one end of the unlocking lever that penetrates into the outer lock body presses against the lock cylinder assembly, thereby driving the lock cylinder assembly to achieve the unlocking operation.

Compared with the prior art, the present disclosure has the beneficial effects below:

1. Through the cooperation between the drive gear and the deadbolt clamping tooth, a structurally reliable and highly stable recreational vehicle lock drive mechanism can be achieved. By the meshing connection between a toggle wheel tooth and the deadbolt clamping tooth, the recreational vehicle lock cannot be disconnected during bumpy running A size of the toggle wheel tooth and a size of the deadbolt clamping tooth can be set to be relatively large, and a certain space is reserved between meshed positions of the toggle wheel tooth and the deadbolt clamping tooth, so that when a recreational vehicle shakes dramatically, there is a certain space for movement between the wheel tooth and clamping tooth, which will not directly cause impact and collapse.

2. Since the separate fixing mechanism is separated from a door lock, use of the door lock will not be affected, and the door lock can be protected from being impacted to be damaged. The rotating buckle of the external knob and the locking disk of the outer shell are in buckled connection to each other, so that the exterior handle is fixed on the outer shell. The accommodating spring is also used to achieve a damping effect on the external knob, so that the exterior handle can be stabilized on the outer shell to reduce impact and abnormal noises in a vehicle driving process.

3. The control device can be directly turned off through the locking button, so that both the remote control key and the numerical password cannot be used. This can improve the safety in the event that the remote control key is lost or the password is leaked, and a door lock of the recreational vehicle lock can only be opened through the mechanical key.

Therefore, by the above improvement, the present disclosure can provide a structurally reliable and highly stable deadbolt drive mechanism for a recreational vehicle lock, can further provide a handle fixing mechanism that is stabilized on the outer shell and reduces impact and abnormal noises in a vehicle driving process, and can further provide an intelligent recreational vehicle lock that improves the safety and the convenience and perfects the use experience.

The additional aspects and advantages of the present disclosure will be partially provided in the following descriptions, some of which will become apparent from the following descriptions, or learned through the practice of the present disclosure.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic diagram of an exploded structure of a recreational vehicle lock according to the present disclosure;

FIG. 2 is a schematic structural diagram of a lock body base according to the present disclosure;

FIG. 3 is a schematic structural diagram of a mechanical lock cylinder according to the present disclosure;

FIG. 4 is a schematic structural diagram of a drive gear according to the present disclosure;

FIG. 5 is a schematic structural diagram of a rotating shaft body according to the present disclosure;

FIG. 6 is a schematic structural diagram of a toggle wheel tooth according to the present disclosure;

FIG. 7 is a schematic structural diagram of a sectors gear according to the present disclosure;

FIG. 8 is a schematic diagram of an exploded structure of a drive assembly according to the present disclosure;

FIG. 9 is a schematic diagram of an exploded structure of an outer shell according to the present disclosure;

FIG. 10 is a schematic diagram of an exploded structure of an exterior handle according to the present disclosure;

FIG. 11 is a schematic structural diagram of a limiting convex block according to the present disclosure;

FIG. 12 is a schematic structural diagram of an accommodating chamber according to the present disclosure;

FIG. 13 is a schematic structural diagram of a support rotating shaft according to the present disclosure;

FIG. 14 is a schematic structural diagram of an outer side in an open state according to the present disclosure;

FIG. 15 is a schematic structural diagram of an inner side in an open state according to the present disclosure;

FIG. 16 is a schematic structural diagram of an inner side in a fixed state according to the present disclosure;

FIG. 17 is a schematic structural diagram of an outer side in a fixed state according to the present disclosure;

FIG. 18 is a schematic structural diagram of an outer lock body according to the present disclosure;

FIG. 19 is a schematic structural diagram of an inner lock body according to the present disclosure;

FIG. 20 is a schematic structural diagram of an internal knob according to the present disclosure;

FIG. 21 is a schematic structural diagram of a password setting assembly according to the present disclosure;

FIG. 22 is a schematic structural diagram of a password inputting assembly according to the present disclosure;

FIG. 23 is a schematic structural diagram of a lock cylinder assembly according to the present disclosure;

FIG. 24 is a schematic structural diagram of a remote controller according to the present disclosure; and

FIG. 25 is a schematic diagram of an exploded structure of a remote controller according to the present disclosure.

Reference numerals and names in the drawings are as follows:

110: lock body base; 111: mechanical lock cylinder; 120: deadbolt assembly; 121: deadbolt clamping tooth; 130: drive assembly; 131: drive gear; 132: toggle wheel tooth; 133: rotating shaft body; 134: driven wheel tooth; 135: sector gear; 140: electric lock cylinder; 141: speed reduction motor; 142: driving gear; 210: outer shell; 211: locking disk; 212: locking through hole; 213: support frame; 214: support hole; 221: limiting circular ring; 222: limiting convex block; 223: rotating through hole; 224: bolt stud; 225: support rotating shaft; 226: unlocking lever; 230: accommodating chamber; 231: cavity; 232: accommodating through hole; 233: fixing ring; 234: accommodating spring; 235: bolt hole; 241: rotating grip; 242: rotating buckle; 243: limiting round disk; 244: limiting notch; 310: inner lock body; 311: interior handle; 312: internal knob; 320: outer lock body; 321: exterior handle; 322: internal knob; 323: key dust plug; 330: intelligent control component; 331: control device; 332: control chip; 333: signal receiving device; 334: buzzer; 340: power supply device; 341: battery holder; 342: battery pack; 343: battery cover; 350: password setting assembly; 351: locking button; 352: set button; 353: del button; 354: mute button; 355: reset button; 360: password inputting assembly; 361: number button; 362: ok button; 363: logo button; 370: lock cylinder assembly; 371: spring bolt; 372: unlocking spring; 380: remote control component; 381: remote control chip; 382: signal sending device; 383: remote control locking button; 384: remote control unlocking button; and 385 mechanical key.

### DETAILED DESCRIPTION OF THE EMBODIMENTS

The technical solutions in the embodiments of the present disclosure are clearly and completely described below. Apparently, the described embodiments are merely some embodiments of the present disclosure, rather than all of the embodiments. All other embodiments obtained by a person of ordinary skill in the art based on the embodiments of present disclosure without making creative efforts shall fall within the protection scope of present disclosure.

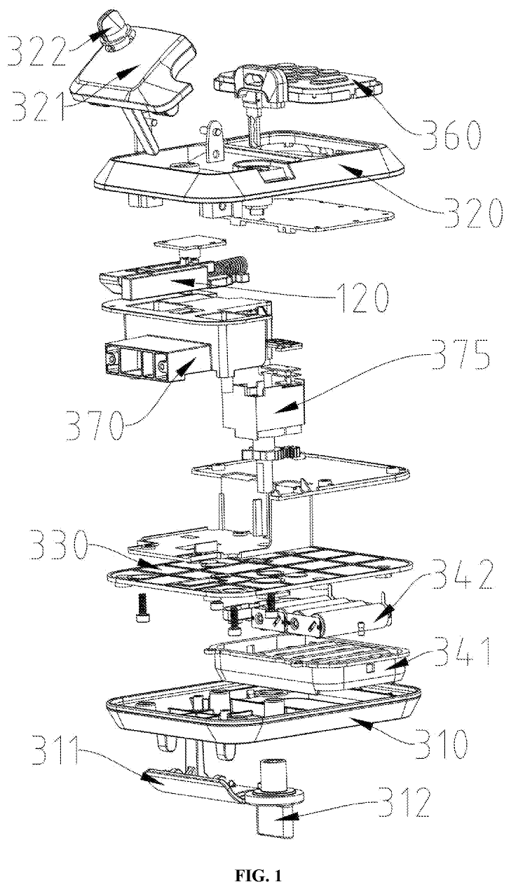

Referring to FIG. 1 to FIG. 8, in the embodiments of the present disclosure, a deadbolt drive mechanism includes a lock body base, a deadbolt assembly mounted on the lock body base, and a drive assembly. The deadbolt assembly and the drive assembly are movably connected to the lock body base; one end of the deadbolt assembly that extends into the lock body base is provided with a deadbolt clamping tooth; the drive assembly is provided with a drive gear; the drive gear is in meshing connection to the deadbolt clamping tooth; and the drive gear drives the deadbolt clamping tooth to drive the deadbolt assembly to move.

Specifically, in order to improve the stability of a recreational vehicle lock, the deadbolt clamping tooth are arranged to be in meshing connection to a toggle wheel tooth, which ensures the stability of a deadbolt during driving. There is at least one deadbolt clamping tooth. For example, when a length of the deadbolt assembly is relatively large, a plurality of deadbolt clamping teeth can be arranged. There may be also a plurality of toggle wheel teeth, and the toggle wheel teeth are one more than the deadbolt clamping teeth, because the toggle wheel teeth need to perform forwarding and reversing operations on the deadbolt clamping teeth, achieving both locking and unlocking effects.

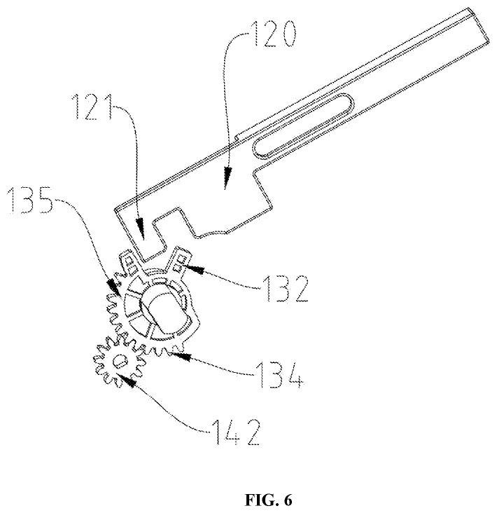

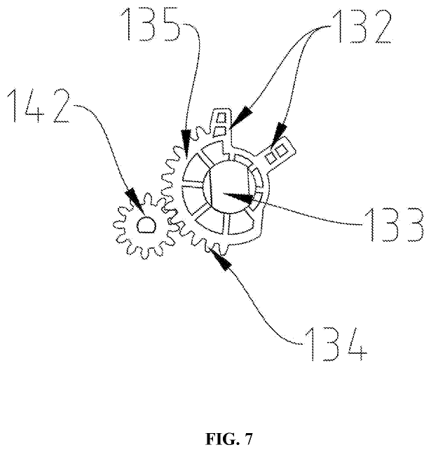

As shown in FIG. 6 and FIG. 7, the drive gear is provided with at least two toggle wheel teeth. The toggle wheel teeth are in meshing connection to the deadbolt clamping tooth, and the toggle wheel teeth drive the deadbolt clamping tooth to drive the deadbolt assembly to move. Specifically, the meshing connection between the toggle wheel teeth and the deadbolt clamping tooth is a loose connection, that is, there can be a certain space between the toggle wheel teeth and the deadbolt clamping tooth. On the basis of ensuring that the toggle wheel teeth can drive the deadbolt clamping tooth, reserving a certain space can prevent the deadbolt assembly from damaging the deadbolt clamping tooth or the toggle wheel teeth during the driving and shaking of a recreational vehicle. A size of the toggle wheel teeth and a size of the deadbolt clamping tooth can be set to be relatively large to increase their structural strength and improve the reliability of the drive mechanism.

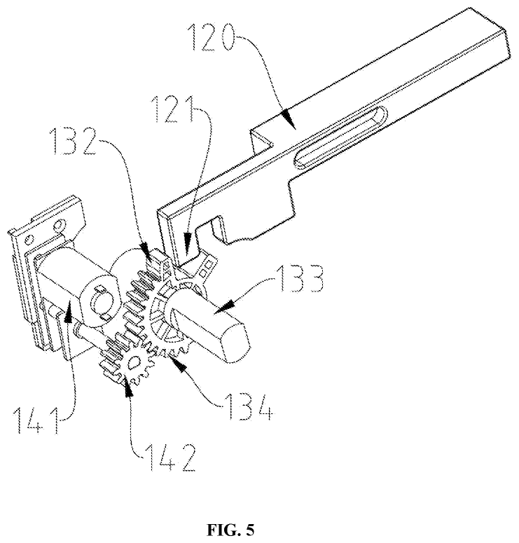

As shown in FIG. 5, the drive assembly is provided with a rotating shaft body; the rotating shaft body is movably connected to the lock body base; the drive gear and the rotating shaft body are coaxially arranged and are fixedly connected to each other; and the drive gear rotates synchronously with the rotating shaft body. Specifically, the drive gear and the rotating shaft body can be an integrated component, or can be two components that are assembled to form an integrated component.

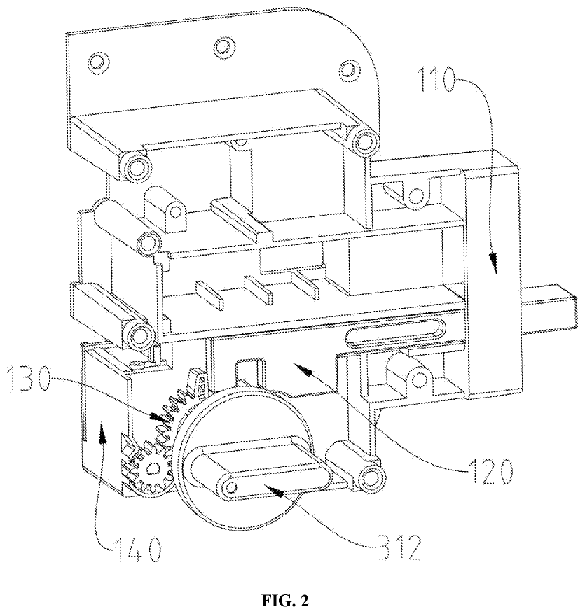

As shown in FIG. 2 to FIG. 4, the deadbolt drive mechanism includes an internal knob; a central axis of the internal knob overlaps a central axis of the rotating shaft body; the internal knob is in interference fit with the rotating shaft body to form a fixed connection; and the internal knob drives the rotating shaft body to rotate. Specifically, the internal knob can drive the rotating shaft body to rotate, thus driving the drive gear to synchronously rotate, so that the toggle wheel teeth generate a toggle thrust on the deadbolt clamping tooth, and the deadbolt assembly moves a certain distance, to achieve a locking or unlocking operation.

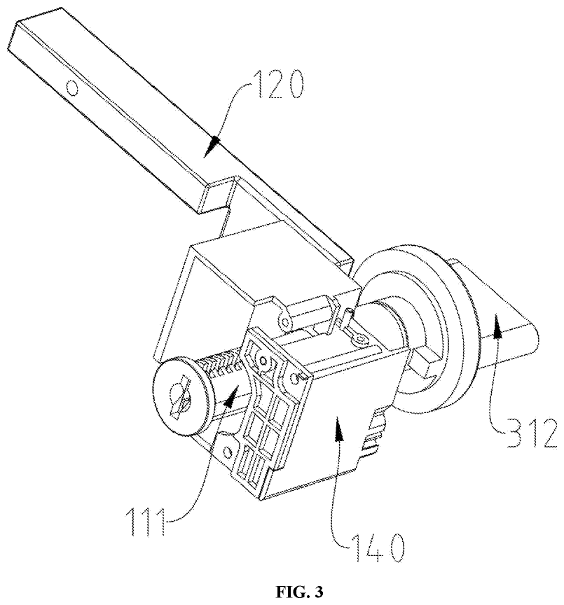

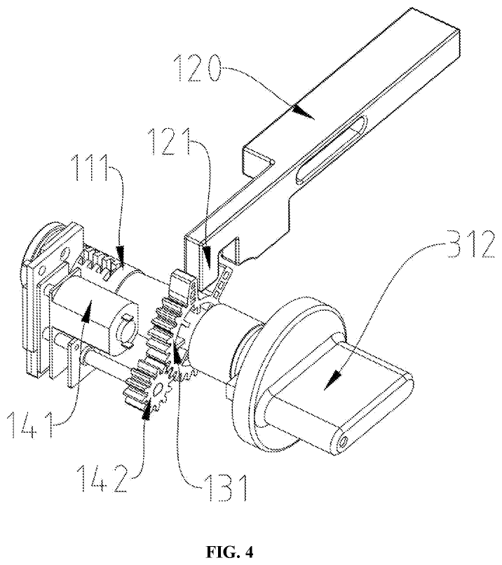

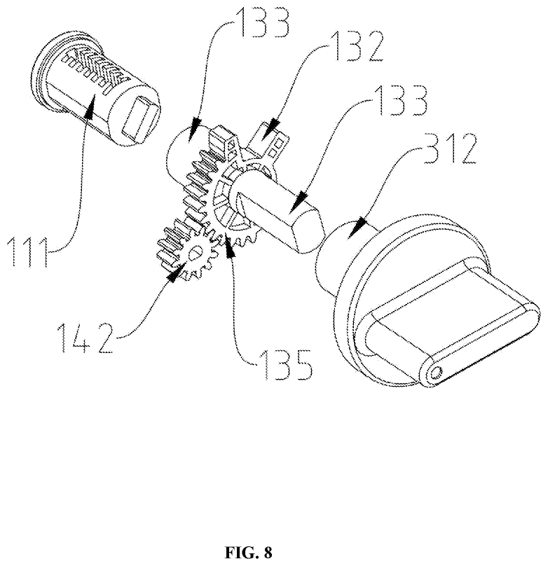

As shown in FIG. 3, FIG. 4, and FIG. 8, the deadbolt drive mechanism further includes a mechanical lock cylinder; a central axis of the mechanical lock cylinder overlaps a central axis of the rotating shaft body; the mechanical lock cylinder is in buckled connection with the rotating shaft body; and the mechanical lock cylinder drives the rotating shaft body to rotate. Specifically, the mechanical lock cylinder can directly sleeve the rotating shaft body, or is in buckled connection through cooperation between a clamping block and a buckling block, as long as the mechanical lock cylinder is opened using a key and can be synchronously rotated by rotating the key, to drive the rotating shaft body to synchronously rotate to perform the unlocking or locking operation.

As shown in FIG. 4 and FIG. 5, the deadbolt drive mechanism further includes an electric lock cylinder; the electric lock cylinder is connected to the lock body base; the electric lock cylinder is in meshing connection to the drive assembly; and the electric lock cylinder drives the drive assembly to rotate to drive the deadbolt clamping tooth to move. The electric lock cylinder is provided with a speed reduction motor and a driving gear; the speed reduction motor is connected to the lock body base; the driving gear is connected to an output shaft of the speed reduction motor; and the speed reduction motor drives the driving gear to rotate. Specifically, the speed reduction motor can be formed by combining a separate motor with a separate speed reducer, or can use a separate speed reduction motor. Preferably, a separate four-stage speed reduction motor is used because of its compact internal structure and higher reliability. Preferably, the four-stage speed reduction motor is used.

As shown in FIG. 5 to FIG. 7, the drive gear is provided with a driven wheel tooth; the driven wheel tooth form a sector gear; and the sector gear is in meshing connection to the driving gear, so that the driving gear drives the sector gear to rotate and drives the drive gear to rotate. A central angle of the sector gear is set to be greater than 45 degrees or less than 90 degrees. Specifically, the drive gear is a specially-shaped gear. One part is set as the toggle wheel teeth, and the other part is set as the driven wheel tooth. The driven wheel tooth forms a continuous sector gear. The sector gear is in meshing connection to the driving gear. The driven wheel tooth is the same as a gear tooth of the driving gear, which can better achieve connection drive and also improve the stability. The central angle of the sector gear cannot be too small, which is not conducive to the connection of the driving gear. The central angle cannot be too large, which wastes lots of materials.

During use, the deadbolt drive mechanism is mounted on the recreational vehicle lock. The locking or unlocking operation can be performed by using the internal knob inside the recreational vehicle, or the mechanical lock cylinder can also be operated using the key outside the recreational vehicle, so as to achieve the locking or unlocking operation. In addition, the electric lock cylinder can also be used to lock or unlock the recreational vehicle lock.

The rotating shaft body can be flexibly connected to the lock body base in a sleeving manner. Preferably, the rotating shaft body is flexibly connected to the lock body base through a bearing. The bearing is more reliable and more stable. The deadbolt assembly can be slidably connected to the lock body base, and a sliding chute that matches the deadbolt assembly is arranged on the lock body base, so that the deadbolt assembly can slide in the sliding chute. The rotating shaft body drives the toggle wheel teeth to move and drives the deadbolt clamping tooth to move, so that the deadbolt assembly can move a certain distance to lock or unlock the recreational vehicle lock.

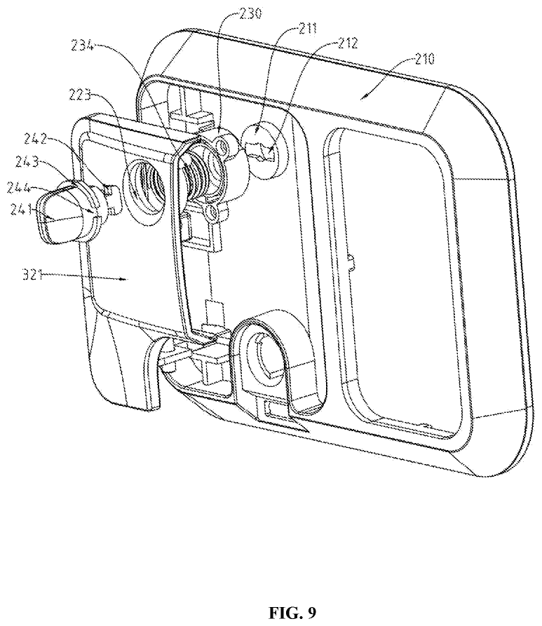

Referring to FIG. 9 to FIG. 17, in still another embodiment of the present disclosure, a handle fixing mechanism includes an outer shell, an exterior handle movably connected to the outer shell, and an external knob used for stabilizing the exterior handle. The outer shell is provided with a locking disk and a locking through hole; the exterior handle is provided with a limiting circular ring, a rotating through hole, and an accommodating chamber; the limiting circular ring is located around the rotating through hole and is fixedly connected to the exterior handle; the accommodating chamber is connected to a limiting circular ring; the external knob is mounted in a cavity formed between the limiting circular ring and the accommodating chamber; the cavity limits a movement range of the external knob; one end of the external knob is provided with a rotating grip; the rotating grip passes through the rotating through hole and protrudes out of the exterior handle; the rotating grip is held to rotate the external knob; the other end of the external knob is provided with a rotating buckle; the accommodating chamber is provided with an accommodating through hole; and the rotating buckle is buckled on the locking disk through the accommodating through hole and the locking through hole to stabilize the exterior handle on the outer shell.

Specifically, a door handle of a vehicle is configured to open a door lock and open a vehicle door. However, after the vehicle door is locked, the door handle remains in a movable state. When the vehicle is in driving at a high speed or experiencing severe bumps, the door handle easily shakes, making abnormal noises, affecting the feeling of passengers inside the vehicle, and even causing damage to the door lock. A separate fixing mechanism can be used to fix the door handle on an outer shell of the door lock through the assistance of a buckle and an accommodating spring, which avoids shaking or joggling, reduce the occurrence of the abnormal noises, and also avoids the occurrence of an accidental damage to the door lock. The exterior handle can be provided with an unlocking lever which is configured to toggle a spring bolt of the door lock to open the door lock. In a case that the door lock is closed, the exterior handle is stabilized by the fixing mechanism to avoid shaking or joggling.

Preferably, the rotating through hole is formed in the exterior handle. The external knob passes through the rotating through hole, with one part left outside the exterior handle for easy holding by the user, and the other part passing through the locking through hole of the outer shell and being in buckled connection to the locking disk of the outer shell, so that the exterior handle is stably fixed on the outer shell. This reduces the shaking or joggling of the exterior handle. The exterior handle is further provided with the limiting circular ring and the accommodating chamber to form the cavity, and the cavity can be internally provided with the accommodating spring, so that the external knob is pressed on the limiting circular ring by an elastic force of the accommodating spring.

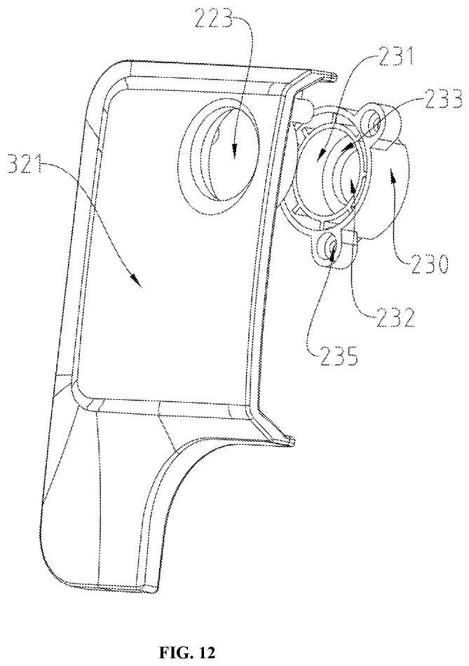

As shown in FIG. 9 and FIG. 12, the accommodating chamber is provided with a fixing ring and an accommodating spring; the fixing ring is arranged around the accommodating through hole and is fixedly connected to the accommodating chamber; and one end of the accommodating spring presses against the fixing ring. The external knob is provided with a limiting round disk; the limiting round disk is connected to a middle position of the external knob; the other end of the accommodating spring presses against the limiting round disk, and the accommodating spring is configured to enable the limiting round disk to press against the limiting circular ring.

Specifically, due to a damping effect of the accommodating spring, the exterior handle can avoid significant shaking even in severe bumps, which avoids damage caused by the impact on the door lock.

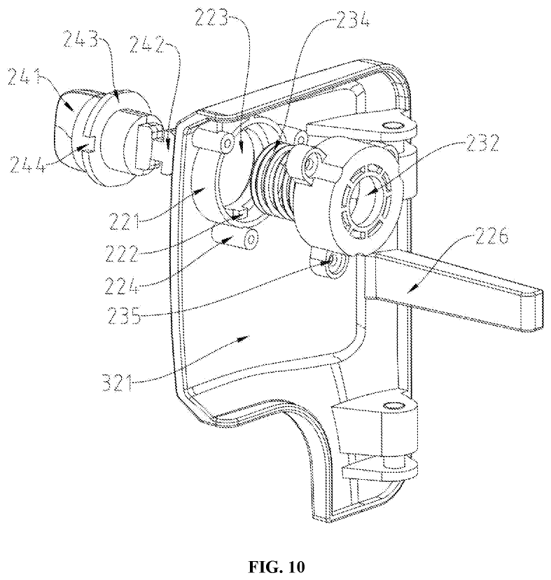

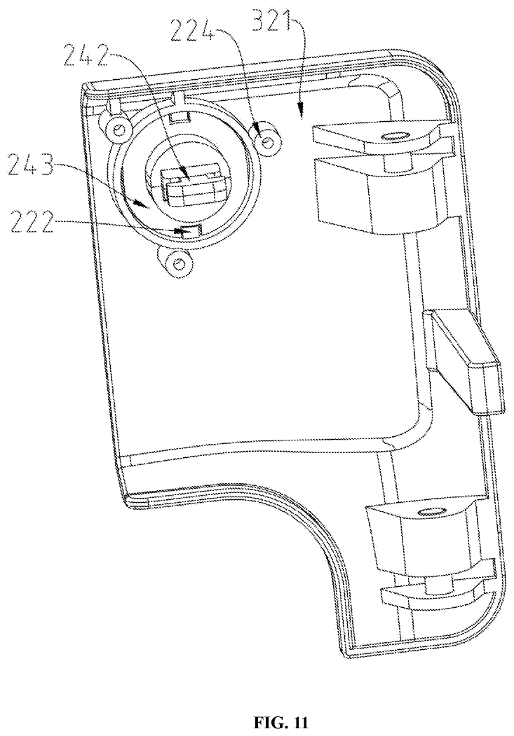

As shown in FIG. 10 and FIG. 11, the exterior handle is provided with a limiting convex block; the limiting convex block is located on the limiting circular ring; the external knob is provided with a limiting notch; the limiting notch is located on the limiting round disk; and the limiting convex block is buckled at the limiting notch to limit a rotation state of the external knob. Specifically, the limiting convex block and the limiting notch are designed to prevent the following phenomenon: After the external knob locks the exterior handle, the external knob may rotate by itself by the shaking in a high-speed driving process of the recreational vehicle or in a process of severe bumps of the recreational vehicle, so that the buckled connection between the rotating buckle and the locking disk will be loosened, and the external knob loses the effect of fixing the exterior handle. The limiting convex block can press against the limiting notch to limit the rotation of a fixed button. When a user opens the vehicle door, the user can hold the rotating grip of the external knob and press the rotating grip a certain distance towards the inside of the outer shell to make the limiting notch leave the limiting convex block. Then, the user rotates the rotating grip to separate the rotating buckle from the locking disk and make the rotating buckle retract from the locking through hole, thus achieving correct unlocking. Then, the user can pull the exterior handle and rotate the exterior handle to drive the unlocking lever to rotate synchronously, thereby pulling the spring bolt of the door lock and correctly opening the door lock.

Preferably, the limiting convex block can be arranged on the exterior handle, and the limiting notch can be arranged on the external knob, so as to limit accidental rotation of the external knob. A limiting groove (not shown in the figure) can also be arranged on the locking disk of the outer shell, so that when the rotating buckle is fixed to the outer shell, the rotating buckle can be buckled onto the locking disk and located in the limiting groove, achieving the effect of limiting the rotation of the external knob.

As shown in FIG. 9 and FIG. 11, the rotating buckle is set to be a straight type buckle; the locking through hole is set to be a straight type through hole; and when the straight type buckle and the straight type through hole cooperate with each other to form a parallel state, the rotating buckle can pass through the locking through hole. Specifically, the straight type buckle and the straight type through hole are the most preferred solution because correct unlocking can be achieved only when the straight type buckle and the straight type through hole are in the parallel state. The door lock is in a locked state when the buckle and the through hole are in other states. The locking disk has a largest region to lock the rotating buckle, which improves the stability of the external knob.

As shown in FIG. 10, the exterior handle is provided with a bolt stud, and the accommodating chamber is provided with a bolt hole. The bolt stud and the bolt hole cooperate to form a bolted connection. Preferably, the accommodating chamber is fixed on the exterior handle through the bolted connection, or other fixed connection methods, such as screw connection or adhesive connection.

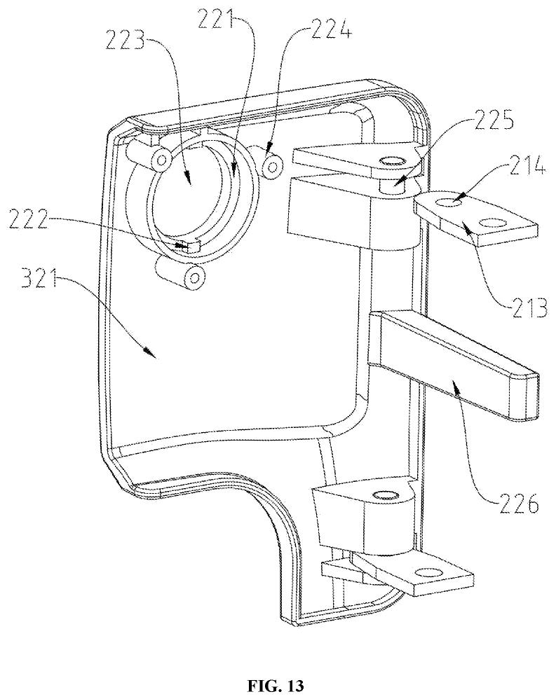

As shown in FIG. 13, the outer shell is provided with a support frame and a support hole; the support frame is fixedly connected to the outer shell; and the support hole is located o the support frame. The exterior handle is provided with a support rotating shaft fixedly connected to the exterior handle, and the support rotating shaft passes through the support hole to form a rotatable connection, causing the exterior handle to rotate at a certain angle. The support frame, the support hole, and the support rotating shaft are just one of connection methods. Any connection method that can make the exterior handle rotate a certain distance on the outer shell can be used, such as bolted connection and hinged connection.

During use, the fixing mechanism is mounted in a recreational vehicle lock. When a recreational vehicle is in driving, the fixing mechanism can firmly fix the exterior handle of the recreational vehicle lock on the outer shell to reduce the shaking or joggling of the exterior handle, thereby reducing abnormal noises and protecting the lock from being damaged by the impact of the exterior handle.

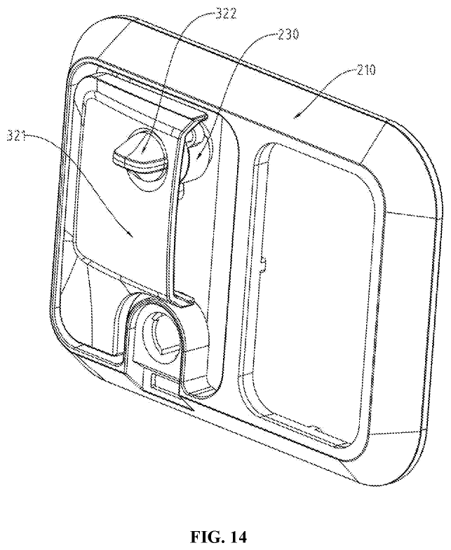

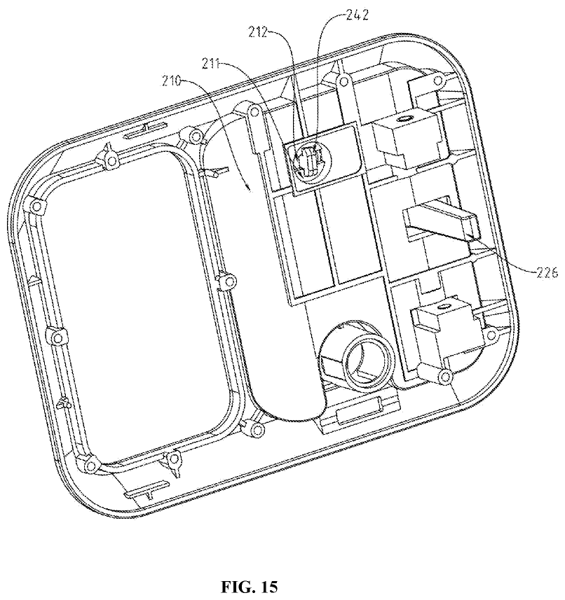

As shown in FIG. 14 and FIG. 15, the fixing mechanism is in an opened state. At this time, the rotating buckle and the locking through hole are in the parallel state, so that the rotating buckle can freely pass through the locking through hole. Therefore, the exterior handle can be rotated at a certain angle to make the unlocking lever rotate synchronously, thus forming a toggling function on the spring bolt of the lock, causing the spring bolt to move a certain distance, and achieving an unlocking effect.

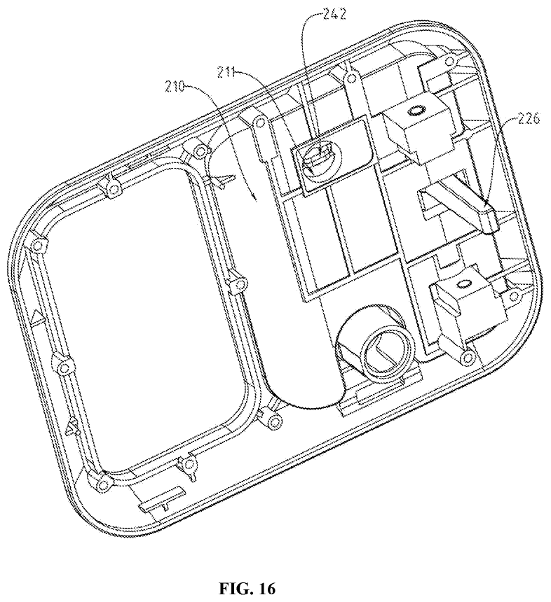

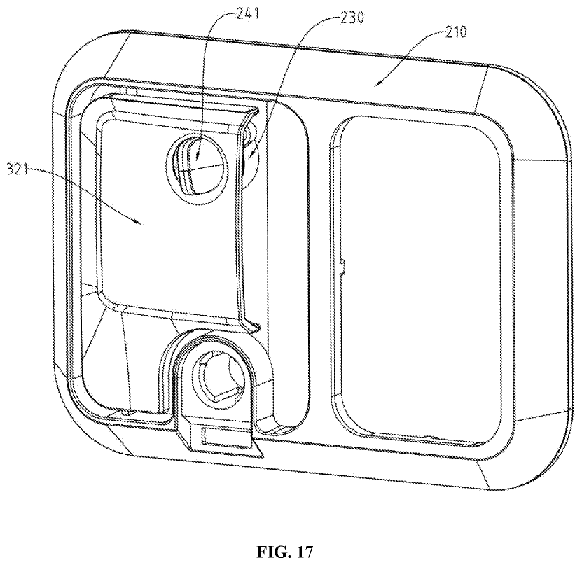

As shown in FIG. 16 and FIG. 17, when the vehicle door is closed and the exterior handle needs to be locked, the rotating grip of the external knob can be held and is pressed a certain distance towards the inside of the outer shell, so that the limiting notch leaves the limiting convex block. Then, the rotating grip can be rotated to make the external knob rotate and drive the rotating buckle to rotate synchronously, so that the rotating buckle passes through the locking through hole and changes from the state of being parallel to the locking through hole to a state of forming at a certain angle with the locking through hole, where the rotating buckle is rotated to be buckled on the locking disk, thus achieving a locking state. Locking the exterior handle to the outer shell can prevent the exterior handle from shaking or joggling during vehicle driving or in bumps, which reduces abnormal noises and also reduces the risk that the door lock is damaged.

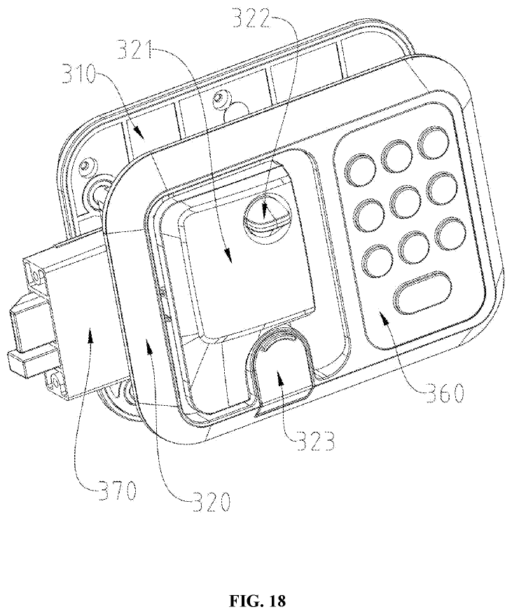

Referring to FIG. 18 to FIG. 25, in another embodiment of the present disclosure, an intelligent recreational vehicle lock includes an inner lock body, an outer lock body, a lock cylinder assembly, and an intelligent control component. The lock cylinder assembly is connected between the inner lock body and the outer lock body, and the intelligent control component is electrically connected to the lock cylinder assembly and controls opening and closing of the lock cylinder assembly; the lock cylinder assembly is provided with an electric lock cylinder; the intelligent control component is provided with a control device, a power supply device, a password setting assembly, and a password inputting assembly; the control device is electrically connected to the electric lock cylinder, the power supply device, the password setting assembly, and the password inputting assembly; the power supply device is configured to provide power; the password setting assembly is configured to set a numerical password; the password inputting assembly is configured to input the numerical password; the control device is configured to compare whether the input numerical password and a set numerical password are consistent, and drive the electric lock cylinder to achieve opening and closing operations; the password setting assembly is provided with a locking button; the locking button is electrically connected to the control device; and the locking button is configured to turn off the control device, so that the control device cannot control the electric lock cylinder to perform the opening and closing operations.

Specifically, the intelligent recreational vehicle lock is a novel lock developed on the basis of an original mechanical lock. The control chip is used to store and process digital signals and digital data to achieve an intelligent operation to a certain extent. The intelligent control component generally includes the power supply device that provides operating power and the control device that computes, processes, and stores data. The power supply device may include a battery holder, a battery pack, and a battery cover in the prior art. The battery holder is fixedly connected to the inner lock body; the battery pack is movably connected inside the battery holder; the battery cover is buckled at an opening of the battery holder; and the battery pack is electrically connected to the control device. The control device may also include the control chip. The control chip is configured to compute, process, and store data. A separate storage device (not shown in the figure) can also be arranged as needed to store data separately.

In addition, in order to achieve intelligent unlocking and locking, it is necessary to configure an electronic unlocking method, such as setting a numerical electronic password, a remote control password, a fingerprint password, and a facial password. For the sake of simplicity and convenience for users, it is preferred to set the numerical electronic password and the remote control password. For a possible situation such as leakage of the numerical electronic password or loss of the remote control password, or a situation where the intelligent control component do not respond due to an unknown factor, the separate locking button can also be arranged to simply and quickly turn off the intelligent control component by one click, ensuring personal and property safety. When the user activates the locking button, an electronic part of the intelligent recreational vehicle lock is locked, only mechanical equipment is operated normally, the remote control component fails, and the a password button fails. After the locking button is released, the intelligent recreational vehicle lock returns to its normal working state.

The control device can use some existing program functional modules to compare the input numerical password with the set numerical password. For example, the control device first compares whether a numerical password input by the user on the password inputting assembly with a numerical password pre-stored in the control device. If they are consistent, the control device controls the electric lock cylinder to rotate to achieve unlocking. If they are inconsistent, the control device does not drive the electric lock cylinder to rotate, but can use button light (not shown in the figure) or a buzzer to prompt the user, making the user aware that a wrong password may be input and have to input the correct password to achieve unlocking.

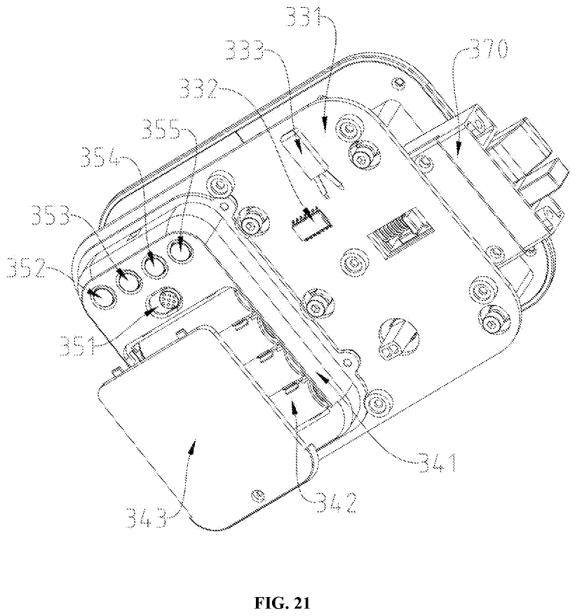

As shown in FIG. 21, the password setting assembly is provided with a set button, a del button, a mute button, and a reset button which are electrically connected to the control device; the set button is configured to preset a corresponding password; the del button is configured to delete the corresponding password; the mute button is configured to enable the control device to send a muting signal; and the reset button is configured to restore factory settings of the intelligent control component.

Specifically, for the set button, after the user completes the mounting of the intelligent recreational vehicle lock and powers on the intelligent recreational vehicle lock, the user presses the password setting button to input an unlocking password with 5 to 15 numbers within 60 seconds, and presses the ok button to confirm the setting. The user repeatedly sets the same group of new password twice and presses the ok button to confirm that the password is set successfully. If the logo button is green, accompanied by three beep sounds, it prompts the user of successful password inputting. The password setting assembly has and only has one group of administrator password. The administrator password is unique. After the administrator password is set successfully, the user also sets two additional groups of user passwords by pressing the set key. In addition, if a recreational vehicle is parked for a long time, a battery standby protection function can be activated: A long press is made on the set button; after the buzzer makes a long beep sound, the recreational vehicle lock will enter an active sleep mode; when the user needs to unlock the sleep mode, the user uses a key for unlocking to open a vehicle door and then makes a long press on the set button; and after a long beep sound, the recreational vehicle lock will be released from the active sleep mode.

Further, the del button is a delete button. When the user presses this button, the logo button flashes in red to prompt the user to enter a standby state for changing the password. The user inputs the old password and presses the ok button to confirm the deletion. After the old password is deleted, a logo indicator lamp turns green and is accompanied by a long beep sound (0.5-0.6 seconds) to indicate the user that the deletion is successful. When all three groups of passwords are deleted, the product automatically enters an initial password state. The mute button is a mute button. After the user makes a short press on this button, the control device sends the muting signal to cause the buzzer to enter a mute state. The indicator lamp still works. A short press will release the mute state. For the reset button: After the user presses this button for three times in a row within 3 seconds, the product is restored to the factory settings. Data after matching is remotely controlled to be zeroed, and a remote control button needs to be pressed again for automatic matching before the remote control component can be used again to perform the locking and unlocking operations.

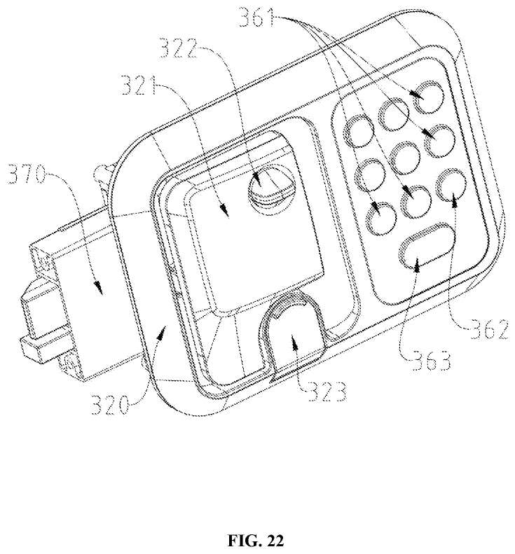

As shown in FIG. 22, the password inputting assembly is provided with a number button, an ok button, and a logo button which are electrically connected to the control device; the number button is configured to input a corresponding numerical password; the ok button is configured to confirm that inputting of the input numerical password has been completed; the logo button is configured to directly send a double-lock signal; and after receiving the double-lock signal, the control device directly controls the electric lock cylinder to perform a locking operation.

Specifically, indicator lamps can be arranged for the number button and the logo button, usually using indicator lamps in three colors: red, blue, and green. For the ok button: This button is pressed for three times in a row within 3 seconds to turn on and turn off the indicator lamps. Specific operation steps include: The user presses any button to wake up a password disk (a number indicator lamp is on, accompanied by a sound made by the buzzer), then inputs a password with 5 to 15 numbers on the number button, and presses the ok button after the inputting of the password is completed, so that the intelligent recreational vehicle lock starts to be unlocked. The function of the logo button is as follows: When the user makes a short press on this button, the deadbolt assembly extends out to directly achieve double lock, so that a shortcut function of one-click double lock is achieved, and the lock is more convenient to use. In addition, after inputting the password, the user can also use the logo button to perform password backspace deletion.

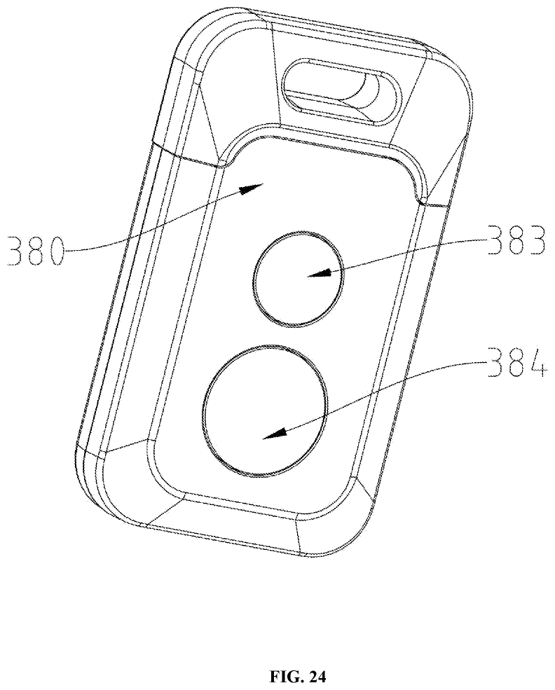

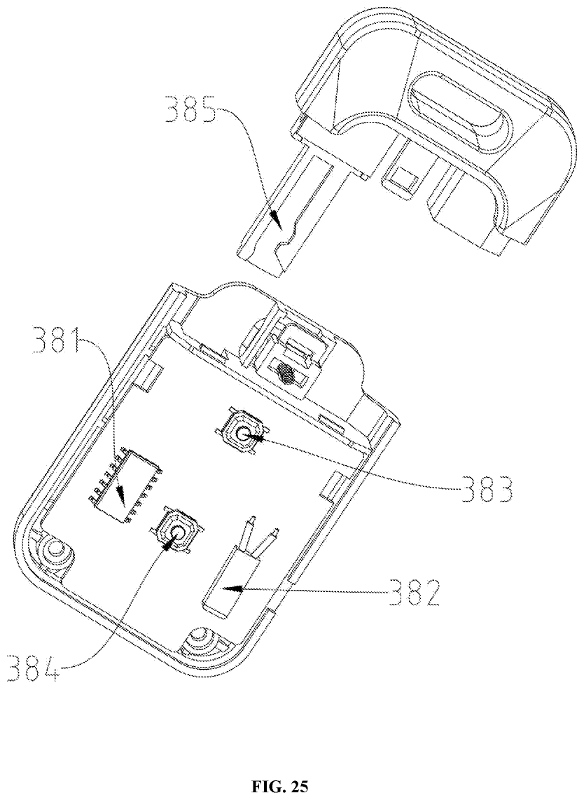

As shown in FIG. 24 and FIG. 25, the intelligent recreational vehicle lock includes a remote control component; the remote control component is provided with a remote control chip and a signal sending device. The remote control chip is electrically connected to the signal sending device. The remote control chip is configured to store preset matching information and generate opening and closing information according to the matching information. The signal sending device is configured to send the opening and closing information to the control device. The remote control component is provided with a remote control locking button and a remote control unlocking button. The remote control chip is electrically connected to the remote control locking button and the remote control unlocking button. The remote control locking button is configured to send an electrical signal for locking, and the remote control unlocking button is configured to send an electrical signal for unlocking.

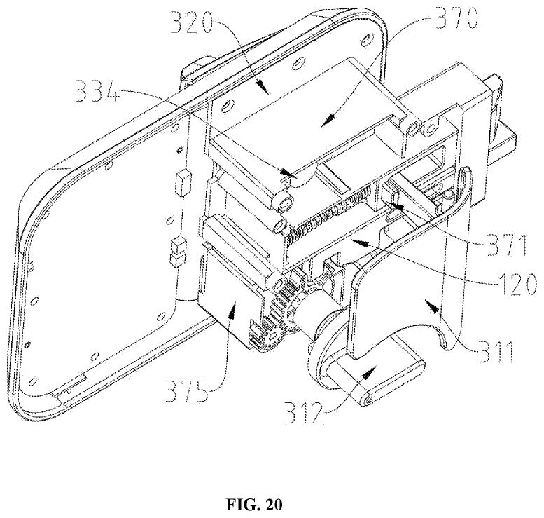

As shown in FIG. 20 and FIG. 21, the control device is provided with a control chip, a signal receiving device, and the buzzer; the control chip is electrically connected to the signal receiving device and the buzzer; the signal receiving device is configured to receive the opening and closing information sent by the signal sending device; the control chip performs corresponding opening and closing control on the electric lock cylinder according to the opening and closing information; and the buzzer is configured to make a prompt tone or enter the mute state according to a signal sent by the control chip.

Specifically, before use, it is necessary to perform a matching operation on the remote control component, which is equivalent to performing one-on-one binding on the current remote control component and the current intelligent control component, so that the current intelligent recreational vehicle lock can only be remotely controlled to be unlocked or locked using the current remote control component. In the specific process of the matching operation, matching is started by making a long press on a plurality of buttons simultaneously. For example, a long press simultaneously made on both the set button and the del button can activate the matching function of the intelligent control component. At the same time, a long press simultaneously made on both the remote control locking button and the remote control unlocking button can also activate the matching function of the remote control chip. After the above two matching functions are activated simultaneously, the remote control component is placed close to the intelligent recreational vehicle lock, so that the remote control chip generates corresponding unique matching information according to relevant equipment information of the remote control component, and the signal sending device is used to send the matching information to the signal receiving device of the intelligent control component. After the control chip receives the above matching information through the signal receiving device, the corresponding matching information is stored in the control chip, indicating successful matching. For unlocking or locking, the remote control component first combines a locking signal or an unlocking signal with the previously generated matching information, and then sends combined information to a signal control device. After receiving the combined information, the control chip first generates corresponding matching information according to the combined information, and compares the generated matching information with the preset matching information stored in the control chip. If the matching information is consistent, the control chip then reads unlocking or locking information in the combined information and performs corresponding opening and closing operations on the electric lock cylinder according to the corresponding information.

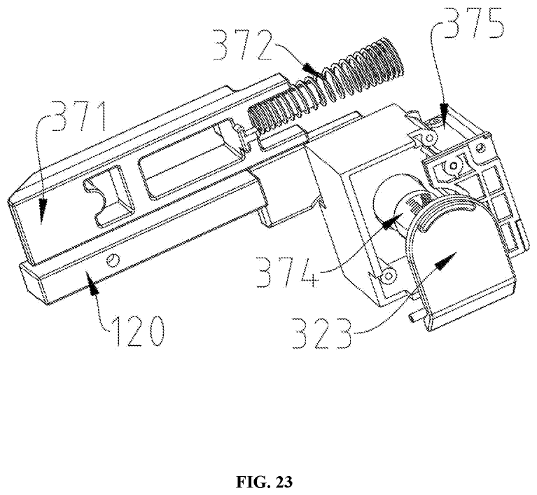

As shown in FIG. 20 and FIG. 23, the lock cylinder assembly is provided with a spring bolt, an unlocking spring, a deadbolt assembly, and a mechanical lock cylinder. The spring bolt is movably connected to the lock cylinder assembly; one end of the unlocking spring presses against the spring bolt, and the other end of the unlocking spring presses against the lock cylinder assembly. The deadbolt assembly is movably connected to the lock cylinder assembly, and the mechanical lock cylinder is fixedly connected to the lock cylinder assembly. The mechanical lock cylinder is in buckled connection to the electric lock cylinder and drives the deadbolt assembly to move a certain distance to perform the opening and closing operations on the recreational vehicle lock.

As shown in FIG. 25, the remote control component is provided with a mechanical key; the mechanical key is movably connected to the remote control component; and the mechanical key is configured to open the mechanical lock cylinder to perform the opening and closing operations on the recreational vehicle lock.

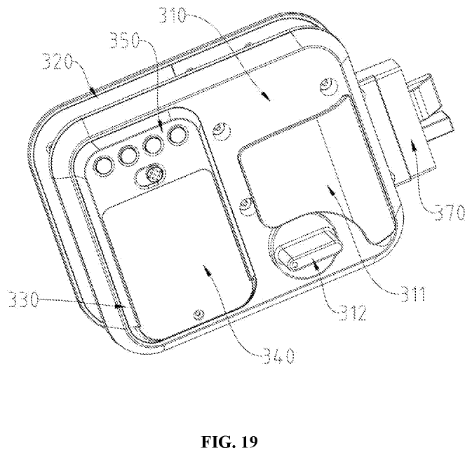

As shown in FIG. 19, the inner lock body is provided with an interior handle and an internal knob. The interior handle and the internal knob are respectively movably connected to the inner lock body. One end of the interior handle that penetrates into the lock cylinder assembly presses against the spring bolt, and the interior handle is configured to drive the spring bolt to achieve the unlocking operation. One end of the internal knob that penetrates into the lock cylinder assembly sleeves a rotating shaft of the mechanical lock cylinder. The internal knob is configured to drive the rotating shaft to rotate and drive the deadbolt assembly to achieve the opening and closing operations of the lock cylinder assembly.

As shown in FIG. 22, the outer lock body is provided with an exterior handle, an external knob, and a key dust plug. The exterior handle is movably connected to the outer lock body. One end of the exterior handle that penetrates into the lock cylinder assembly presses against the spring bolt. The exterior handle is configured to drive the spring bolt to achieve the unlocking operation. The external knob is movably connected to the exterior handle, and the external knob is configured to stabilize the exterior handle on the outer lock body. The key dust plug is movably connected to the outer lock body and covers a lock hole of the mechanical lock cylinder. The key dust plug is configured to prevent foreign matters from entering the lock hole of the mechanical lock cylinder.

Specifically, the arrangement of the spring bolt and the unlocking spring mainly provides an ordinary locking method for the intelligent recreational vehicle lock. This method does not have a safety function. The spring bolt can be directly toggled by the interior handle or the exterior handle to directly open the recreational vehicle lock. This function is mainly used for performing ordinary locking on the vehicle door when the user does activities around the recreational vehicle, which mainly prevents air or other foreign matters or animals from entering the recreational vehicle. A shell of the lock cylinder assembly is provided with corresponding limiting sliding chutes, and the spring bolt, the unlocking spring, and the deadbolt assembly are all arranged in the corresponding limiting sliding chutes, so that movements of the spring bolt and the deadbolt assembly can be limited in the limiting sliding chutes, and the spring bolt and the deadbolt assembly are also protected, which further improves the safety of the intelligent recreational vehicle lock.

In addition, during the unlocking of the mechanical lock cylinder or the electric lock cylinder, a drive assembly can be driven to rotate, thus driving a deadbolt clamping tooth to move, and the deadbolt assembly can be toggled to open or close the recreational vehicle lock. For ease of carrying, the mechanical key can be arranged on the remote control component. In addition, in order to achieve quick unlocking and locking inside the recreational vehicle, the internal knob can be arranged. The internal knob can directly rotate an unlocking lever to directly achieve unlocking or locking. In order to prevent foreign matters from entering a keyhole of the mechanical lock cylinder, the key dust plug can be arranged on the outer lock body to cover the keyhole. The external knob can also be arranged on the outer lock body to firmly fix the exterior handle on the outer lock body, which reduces shaking or joggling of the exterior handle and reduces abnormal noises.

During use, a matching operation is firstly performed on the remote control component and the intelligent control component, so that the remote control component can achieve the opening and closing operations of the intelligent recreational vehicle lock. Then, corresponding password setting can be performed through the password setting assembly. A total of 3 groups of passwords can be set, including a group of administrator password that is set first and two groups of ordinary passwords that are then set. After the passwords are set, the intelligent recreational vehicle lock can be unlocked through the password inputting assembly. During locking outside the recreational vehicle, the user can directly press the logo button for double lock. During locking inside the recreational vehicle, the user can achieve double lock on the recreational vehicle lock through the internal knob. In addition, in a case of leakage of the password or loss of the remote control component, an electronic component of the intelligent recreational vehicle lock can be locked by directly toggling the locking button, so that the unlocking password and the remote control component fail, thus improving the safety of the intelligent recreational vehicle lock.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure.

What is claimed is:

1. A deadbolt drive mechanism, comprising a lock body base, a deadbolt assembly, and a drive assembly, wherein the deadbolt assembly and the drive assembly are connected to the lock body base; one end of the deadbolt assembly is provided with a deadbolt clamping tooth and extends into the lock body base; the drive assembly is provided with a drive gear; and the drive gear is in meshing connection to the deadbolt clamping tooth to drive the deadbolt assembly to move.

2. The deadbolt drive mechanism according to claim 1, wherein the drive assembly is provided with a rotating shaft body; the rotating shaft body is connected to the lock body base; the drive gear and the rotating shaft body are coaxially arranged and are fixedly connected to each other; and the drive gear rotates synchronously with the rotating shaft body.

3. The deadbolt drive mechanism according to claim 2, wherein the deadbolt drive mechanism further comprises an internal knob; a central axis of the internal knob overlaps a central axis of the rotating shaft body; the internal knob is fixedly connected to the rotating shaft body; and the internal knob drives the rotating shaft body to rotate.

4. The deadbolt drive mechanism according to claim 2, wherein the deadbolt drive mechanism further comprises a mechanical lock cylinder; a central axis of the mechanical lock cylinder overlaps a central axis of the rotating shaft body; the mechanical lock cylinder is in buckled connection with the rotating shaft body; and the mechanical lock cylinder drives the rotating shaft body to rotate.

5. The deadbolt drive mechanism according to claim 1, wherein the deadbolt drive mechanism further comprises an electric lock cylinder; the electric lock cylinder is connected to the lock body base; the electric lock cylinder is in meshing connection to the drive assembly; and the electric lock cylinder drives the drive assembly to rotate to drive the deadbolt assembly to move.

6. The deadbolt drive mechanism according to claim 5, wherein the electric lock cylinder is provided with a speed reduction motor and a driving gear; the speed reduction motor is connected to the lock body base; the driving gear is connected to an output shaft of the speed reduction motor; the speed reduction motor drives the driving gear to rotate; the drive gear is provided with a driven wheel tooth; the driven wheel tooth form a sector gear on the drive gear; the sector gear is in meshing connection to the driving gear, so that the driving gear drives the sector gear to rotate and drives the drive gear to rotate.

7. An intelligent recreational vehicle lock, comprising the deadbolt drive mechanism according to claim 1, further comprising an inner lock body, an outer lock body, a lock cylinder assembly, and an intelligent control component, wherein the lock cylinder assembly is connected between the inner lock body and the outer lock body; the intelligent control component is electrically connected to the lock cylinder assembly and controls opening and closing of the lock cylinder assembly; the lock cylinder assembly is provided with an electric lock cylinder; opening and closing of the electric lock cylinder drives the deadbolt assembly to move, thereby opening and closing the recreational vehicle lock; the intelligent control component is provided with a control device, a power supply device, a password setting assembly, a password inputting assembly, and a locking button which are electrically connected to each other; the password setting assembly is configured to set a numerical password; the password inputting assembly is configured to input the numerical password; the control device is configured to compare whether an input numerical password is consistent with a set numerical password and drive the electric lock cylinder to achieve opening and closing operations; and the locking button is configured to turn off the control device, so that the control device is unable to control the electric lock cylinder to perform the opening and closing operations.

8. The intelligent recreational vehicle lock according to claim 7, wherein the password setting assembly is provided with a set button, a del button, a mute button, and a reset button; the set button is configured to preset a corresponding password; the del button is configured to delete the corresponding password; the mute button is configured to enable the control device to send a muting signal; and the reset button is configured to restore factory settings of the intelligent control component.

9. The intelligent recreational vehicle lock according to claim 7, wherein the password inputting assembly is provided with a number button, an ok button, and a logo button; the number button is configured to input a corresponding numerical password; the ok button is configured to confirm that inputting of the input numerical password has been completed; the logo button is configured to directly send a double-lock signal; and after receiving the double-lock signal, the control device directly controls the electric lock cylinder to perform a locking operation.

10. The intelligent recreational vehicle lock according to claim 7, wherein the intelligent recreational vehicle lock comprises a remote control component; the remote control component is provided with a remote control chip, a signal sending device, a remote control locking button, and a remote control unlocking button which are electrically connected to each other; the remote control locking button is configured to send an electrical signal for locking, and the remote control unlocking button is configured to send an electrical signal for unlocking; the remote control chip is configured to store preset matching information and generate opening and closing information in combination with the electrical signals; and the signal sending device is configured to send the opening and closing information to the control device.

11. The intelligent recreational vehicle lock according to claim 10, wherein the control device is provided with a control chip, a signal receiving device, and a buzzer which are electrically connected to each other; the signal receiving device is configured to receive the opening and closing information sent by the signal sending device; the control chip performs corresponding opening and closing control on the electric lock cylinder according to the opening and closing information; and the buzzer is configured to make a prompt tone or enter a mute state according to a signal sent by the control chip.

12. The intelligent recreational vehicle lock according to claim 10, wherein the lock cylinder assembly is further provided with a mechanical lock cylinder; the mechanical lock cylinder is connected to the lock cylinder assembly; the mechanical lock cylinder is in buckled connection to the deadbolt assembly and drives the deadbolt assembly to move a certain distance to perform the opening and closing operations on the recreational vehicle lock; the inner lock body is further provided with an internal knob; one end of the internal knob that penetrates into the lock cylinder assembly is connected to a rotating shaft of the mechanical lock cylinder; and the internal knob is configured to drive the rotating shaft to rotate and drive the deadbolt assembly to move to perform the opening and closing operations on the recreational vehicle lock.

13. The intelligent recreational vehicle lock according to claim 12, wherein the remote control component is provided with a mechanical key; the mechanical key is fixedly connected to the remote control component in a removable manner; and the mechanical key is configured to open the mechanical lock cylinder.

14. The intelligent recreational vehicle lock according to claim 7, wherein the lock cylinder assembly is further provided with a spring bolt and an unlocking spring; the spring bolt is movably connected to the lock cylinder assembly; one end of the unlocking spring presses against the spring bolt, and the other end of the unlocking spring presses against the lock cylinder assembly; the inner lock body is further provided with an interior handle; one end of the interior handle that penetrates into the lock cylinder assembly presses against the spring bolt; and the interior handle is configured to drive the spring bolt to achieve an unlocking operation.

15. A handle fixing mechanism, comprising the intelligent recreational vehicle lock according to claim 7, and further comprising an outer shell, an exterior handle, and an external knob, wherein the outer shell is connected to the outer lock body and is provided with a locking disk and a locking through hole; the exterior handle is provided with a limiting circular ring, a rotating through hole, an accommodating chamber, and an accommodating through hole; the accommodating chamber is fixedly connected to the limiting circular ring and forms a cavity; the external knob is mounted in the cavity; one end of the external knob is provided with a rotating grip; the rotating grip passes through the rotating through hole and protrudes out of the exterior handle; the other end of the external knob is provided with a rotating buckle; and the rotating buckle is buckled on the locking disk through the accommodating through hole and the locking through hole.

16. The handle fixing mechanism according to claim 15, wherein the accommodating chamber is provided with a fixing ring and an accommodating spring; the fixing ring is arranged around the accommodating through hole and is fixedly connected to the accommodating chamber; the external knob is provided with a limiting round disk; one end of the accommodating spring presses against the fixing ring; and the other end presses against the limiting round disk.

17. The handle fixing mechanism according to claim 16, wherein the exterior handle is provided with a limiting convex block; the limiting convex block is located on the limiting circular ring; the external knob is provided with a limiting notch; the limiting notch is located on the limiting round disk; and the limiting convex block is in buckled connection to the limiting notch to limit a rotation state of the external knob.

18. The handle fixing mechanism according to claim 15, wherein the rotating buckle is set to be a straight type buckle; the locking through hole is set to be a straight type through hole; and the rotating buckle and the locking through hole cooperate with each other, so that the rotating buckle passes through the locking through hole.

19. The handle fixing mechanism according to claim 15, wherein the outer shell is provided with a support frame and a support hole; the support frame is fixedly connected to the outer shell; the exterior handle is provided with a support rotating shaft; and the support rotating shaft passes through the support hole to form a rotatable connection.

20. The handle fixing mechanism according to claim 15, wherein the exterior handle is provided with an unlocking lever; and one end of the unlocking lever that penetrates into the outer lock body presses against the lock cylinder assembly, thereby driving the lock cylinder assembly to achieve the unlocking operation.
